(19) United States
(12) Patent Application Publication
(10) Pub. No.: US 2008/0110409 A1
(43) Pub. Date: May 15, 2008

(54) TRANSPORT VEHICLE FOR TRANSPORTING CHICKENS AND METHOD FOR VENTILATING A COMPARTMENT THEREOF

(76) Inventor: Adrianus Henricus Maria Mennen, Vlierden (NL)

Correspondence Address: LAW OFFICES OF ERIC KARICH, 2807 ST. MARK DR., MANSFIELD, TX, 76063, US

(21) Appl. No.: 11/954,559

(22) Filed: Dec. 12, 2007

Related U.S. Application Data
(63) Continuation-in-part of application No. 11/107,310, filed on Apr. 15, 2005, now abandoned.

(51) Int. Cl. B60P 3/04; B60H 1/00

(52) U.S. Cl. 119/401; 454/118

(57) ABSTRACT

A transport vehicle for transporting animals such as chickens has a compartment and front and rear ventilating fans. The compartment includes a front wall and an opposing rear wall, connected by a roof, a floor and two side walls. The front ventilating fan is situated in or near an opening in the front wall for extracting air from the compartment. The rear ventilating fan is situated in or near an opening in the rear wall for extracting air from the compartment. The compartment further includes an air vent for allowing air into the compartment. A controller operably connected to the front and rear ventilating fans for alternately activating the front ventilating fan and then the rear ventilating fan.

### CROSS-REFERENCE TO RELATED APPLICATIONS

This application for a utility patent is a continuation-in-part of a previously filed utility patent, currently pending, having the application Ser. No. 11/107,310, filed Apr. 15, 2005. The previous application is hereby incorporated by reference in its entirety.

### BACKGROUND OF THE INVENTION

1. Field of the Invention

This invention relates generally to vehicles, and more particularly to a transport vehicle for transporting animals such as chickens, and a method for ventilating a compartment thereof.

2. Description of Related Art

Ventilation systems used to ventilate transport vehicles are well known in the art. Luebke, U.S. Pat. No. 4,454,837, for example, teaches a transport vehicle that blows air into the compartment of the vehicle front the front, and exhausts the air from the rear. A problem with such a system is that the front of the vehicle tends to get too cold, and on particularly cold days, the cold can kill the animals within the compartment.

A similar transport vehicle is disclosed in Mennen, WO 03/031224 A1, which is hereby incorporated by reference in full. The transport vehicle of Mennen discloses a front ventilation fan to exhaust air from the front, and air enters through air vents in the rear wall; however, it has been found that, during cold weather, the temperature in the rear of the compartment gets too low for the animals to survive transportation, and a lot of the animals in the rear of the compartment die.

The prior art teaches ventilating a transport vehicle from the front, and ventilating the transport vehicle from the rear, neither of which is optimal for the health of the animals in the vehicle. However, the prior art does not teach a transport vehicle with includes both front and rear ventilation fans, and a controller for alternately activating first the front ventilating fan, then the rear ventilating fan, so that the optimal temperature is maintained throughout the compartment of the vehicle. The present invention fulfills these needs and provides further related advantages as described in the following summary.

### SUMMARY OF THE INVENTION

The present invention teaches certain benefits in construction and use which give rise to the objectives described below.

The present invention provides a transport vehicle for transporting animals such as chickens. The transport vehicle includes a compartment with front and rear ventilating fans. The compartment includes a front wall and an opposing rear wall, connected by a roof, a floor and two side walls. The front ventilating fan is situated in or near an opening in the front wall for extracting air from the compartment. The rear ventilating fan is situated in or near an opening in the rear wall for extracting air from the compartment. The compartment further includes an air vent for allowing air into the compartment. A controller operably connected to the front and rear ventilating fans for alternately activating the front ventilating fan and then the rear ventilating fan.

An objective of the invention is to provide a transport vehicle in which ventilation of the compartment is improved. To this end, the transport vehicle according to the invention includes a controller and timer that function to alternatively turn on the front ventilating fan and then the rear ventilating fan, thereby maintaining a more consistent temperature within the vehicle. A consistent temperature within the vehicle is important to prevent the deaths of chickens and other livestock being transported in the vehicle.

Instead of exhausting air only through openings in the front wall such that air is vented into the vehicle through openings in the rear wall of the compartment, as is done in the prior art, the air is alternately exhausted through openings in the front and rear wall whereby the air is alternately taken in through openings in the opposite wall. The air vents in the front and rear walls can be formed by the ventilating fans.

The invention also relates to a method for ventilating a compartment of the transport vehicle, wherein the air is extracted alternately by either the front fan or the rear fan.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The invention will be elucidated more fully below on the basis of drawings in which an embodiment of the transport vehicle according to the invention is shown. In these drawings:

FIG. 1 is a side view of an embodiment of the transport vehicle according to the invention in which the compartment is shown in cross-section;

FIG. 2 is a view from above of a front part of the transport vehicle's compartment;

FIG. 3 is a front view of the compartment; and

FIG. 4 is a rear view of the compartment.

### DETAILED DESCRIPTION OF THE INVENTION

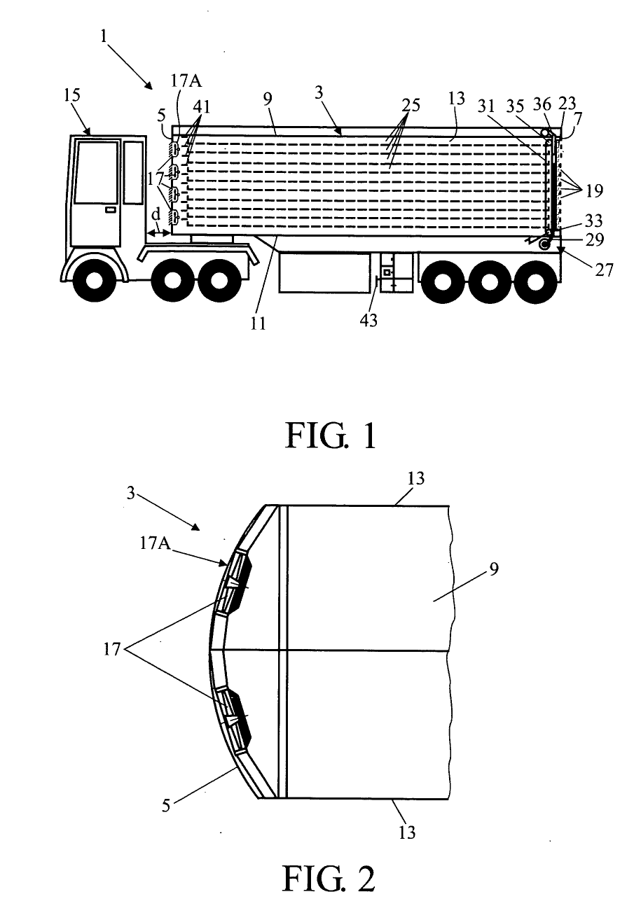

In FIG. 1 an embodiment of the transport vehicle 1 according to the invention is shown in a side view. The transport vehicle 1 is suitable for transporting animals such as chickens, and includes a compartment 3 with, as viewed in the direction of travel, a front wall 5, a rear wall 7, a roof 9, a floor 11 and two side walls 13. For the sake of clarity, the compartment is shown here in cross-section. The transport vehicle 1, furthermore, has a cab 15 situated in front of and at a distance d from the compartment 3.

The transport vehicle 1 includes a front ventilating fan 17 situated in or near an opening 17A in the front wall 5 for extracting air from the compartment 3; a rear ventilating fan 18 situated in or near an opening 18A in the rear wall 7 for extracting air from the compartment 3; and an air vent 19 for allowing air into the compartment 3.

A controller 20 is operably connected to the front and rear ventilating fans 17 and 18 for alternately activating the front ventilating fan 17 and then the rear ventilating fan 18, such that when the front ventilating fan 17 is activated the rear ventilating fan 18 is deactivated, and when the rear ventilating fan 18 is activated the front ventilating fan 17 is deactivated. In the preferred embodiment, the controller is activated by an initiation switch 24 activated by the user.

The transport vehicle 1 preferably further includes a timer 22 for setting a period of time. The timer 22 is operably connected to the controller 20 such that the controller 20 alternates the activation of the front and rear ventilation fans 17 and 18 for the period of time set by the timer 22.

While we discuss the front ventilating fan 17 and the rear ventilating fan 18 in the singular, these terms may include multiple fans. In the preferred embodiment, there are eight front ventilating fans 17 in openings 17A in the front wall 5 of the compartment 3. There are also preferably six rear ventilating fans 18 in openings 18A in the rear wall 7 of the compartment 3. These six further ventilating fans 18 have the same overall venting capacity as four of the ventilating fans 17 in the front wall 5. The ventilating fans are set up in such a way that they extract air from the compartment 3 and blow it outside.

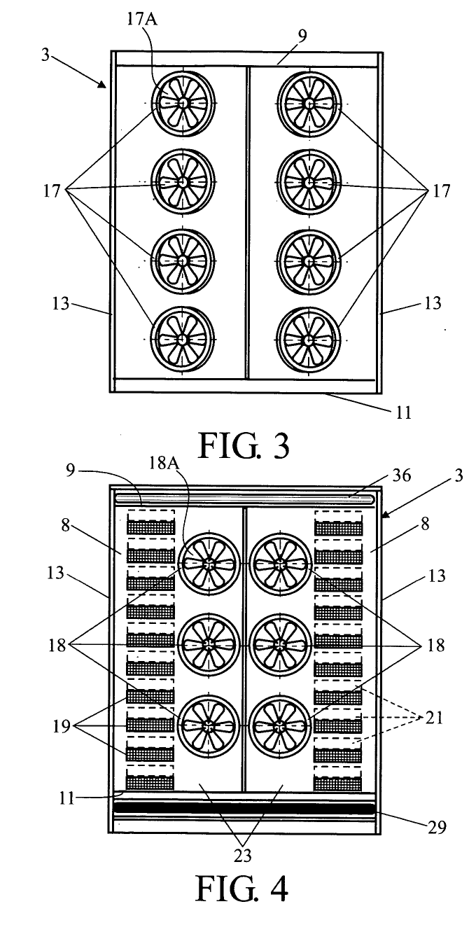

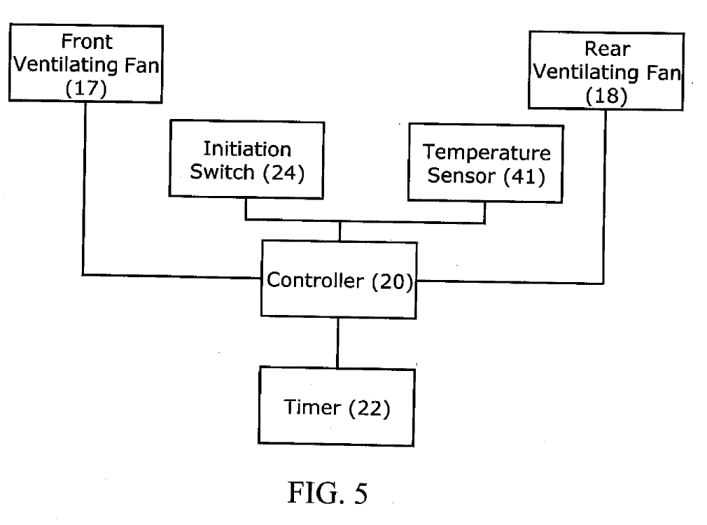

In FIGS. 2 and 3, the position of the ventilating fans 17 in the front wall 5 and in FIG. 4 the position of the further ventilating fans 18 in the rear wall 7 can be seen clearly.

The rear wall 7 of the compartment 3 is made up of two doors 8, see FIGS. 1 and 4. In the rear wall 7 there are a number of air vents 19 for letting fresh air in. The size of the air vents 19 can be adjusted by means of sliding devices 21 (see FIG. 4), which can be slid in front of the air vents 19. There is a sponge 23 made of plastic wire in front of the air vents 19 on the inner side of the rear wall 7. This sponge 23 is a resistance device through which the air flowing into the compartment encounters resistance. The roof 9, the floor 11 and the side walls 13 are closed.

There are a number of floors 25 in the compartment, see FIG. 1. In the compartment 3 at the rear there is a moveable closing device 27 for closing off a part of the rear from the floor 11 upwards. This closing device 27 comprises a plastic covering 29 that can be rolled up and which extends over the entire width of the compartment 3. One end of the plastic covering 29 is attached to cables 31 near the side walls 13 of the compartment 3, which are led round two wheels 33 and 35 at the top and bottom of the compartment 3. One of the wheels 33 can be driven in order to raise or lower the plastic covering 29.

In the compartment 3 at the rear there is further a moving resistance device 36, made of a perforated plastic covering, through which the air flowing into the compartment 3 encounters resistance, for covering a part of the rear from the roof 9 downwards when the doors 8 are open.

For regulating the ventilating fans 17, there are temperature sensors 41 on each floor 25 of the compartment 3 as well as a sensor for the outside temperature 43.

During circumstances when temperature is not low, for example above 5 degrees Celsius, the air is only exhausted by the ventilating fans 17 in the front wall 5 of the compartment 3. In that case the openings in the rear wall 7 wherein the further ventilating fans 18 are present are closed and the air is taken in through the adjustable air vents 19 in the rear wall 7.

During circumstances when temperature is low, for example below 5 degrees Celsius, the air is alternately, for example during periods of 3 minutes, exhausted through openings in the front and rear wall 5, 7 whereby the air is alternately taken in through openings in the opposite wall. The air vents in the front and rear walls 5, 7 are in that case formed by the openings in which the ventilating fans 17, 18 and the adjustable air vents 19 in the rear wall 7 are closed. Because of this the temperature in the compartment and especially in the rear of the compartment will be less low than in case air is only exhausted through openings in the front wall of the compartment 3.

During loading of the compartment in case the outside temperature is low only the ventilating fans 17 in the front wall 5 are operative. After the compartment is loaded the doors 8 are closed and during a time longer than 3 minutes only the further ventilating fans 18 in the rear wall 7 are operative to increase the temperature in the rear of the compartment 3.

Although in the above the invention is explained on the basis of the drawings, it should be noted that the invention is in no way limited to the embodiment shown in the drawings. The invention also extends to all embodiments deviating from the embodiment shown in the drawings within the context defined by the claims. Thus the ventilating fans can also be situated in the side walls 13 near the front of the compartment 3.

1. A transport vehicle for transporting animals, the transport vehicle comprising:
a compartment with, as viewed in the direction of travel, a front wall and an opposing rear wall, connected by a roof, a floor and two side walls;
a front ventilating fan situated in or near an opening in the front wall for extracting air from the compartment;
an air vent for allowing air into the compartment;
a rear ventilating fan situated in or near an opening in the rear wall for extracting air from the compartment; and
a controller operably connected to the front and rear ventilating fans for alternately activating the front ventilating fan and then the rear ventilating fan, such that when the front ventilating fan is activated the rear ventilating fan is deactivated, and when the rear ventilating fan is activated the front ventilating fan is deactivated.

2. The transport vehicle of claim 1, further comprising a timer for setting a period of time, wherein the timer is operably connected to the controller such that the controller alternates the activation of the front and rear ventilation fans for the period of time set by the timer.

3. The transport vehicle of claim 1, further comprising:
a number of floors in the compartment;
a number of additional ventilating fans which are distributed vertically in the front wall;
a number of additional further ventilating fans, which are distributed vertically in the rear wall; and
a number of additional air vents which are distributed vertically in the rear wall adjacent the further ventilating fans.

4. The transport vehicle of claim 1, wherein the rear wall is executed as one or more doors and that there is a movable closing device in the compartment at the rear for closing off a part of the rear from the floor upwards when the doors are open, and a moving resistance device, through which the air flowing into the compartment encounters resistance, for covering a part of the rear from the roof downwards when the doors are open.

5. The transport vehicle of claim 4, wherein the resistance device is a perforated plastic covering.

6. The transport vehicle of claim 4, wherein the closing device comprises a plastic covering that can be rolled up, which extends over the entire width of the compartment.

7. A method for ventilating a compartment of a transport vehicle, the method comprising the steps of:
providing the transport vehicle having:
a compartment with, as viewed in the direction of travel, a front wall and an opposing rear wall, connected by a roof, a floor and two side walls;
a front ventilating fan operably positioned to extract air from the compartment through an opening in the front wall;
an air vent;
a rear ventilating fan operably positioned to extract air from the compartment through an opening in the rear wall;
activating the front ventilating fan while deactivating the rear ventilating fan such that air is extracted from the compartment through the opening in the front wall of the compartment, and such that air enters the compartment through the air vent; and
activating the rear ventilating fan while deactivating the front ventilating fan such that air is extracted from the compartment through the opening in the rear wall of the compartment, and such that air enters the compartment through the air vent.

8. The method of claim 7, further comprising the steps of operably attaching a controller operably to the front and rear ventilation fans, the controller functioning to alternate the activation of the front and rear ventilation fans.

9. The method of claim 8, further comprising the steps of providing a timer, selecting a time interval for the timer, and activating the timer such that the timer governs the length of time between alternating between the front and rear ventilating fans.
